(19) United States
(12) Patent Application Publication
(10) Pub. No.: US 2015/0210789 A1
(43) Pub. Date: Jul. 30, 2015

(54) Polymeric Chelation System

(71) Applicant: Polymerium, LLC, Cheyenne, WY (US)

(72) Inventors: Paul W. Schmalzl, Greenville, SC (US); Robert Warren, San Diego, CA (US)

(21) Appl. No.: 14/417,574

(22) PCT Filed: Jul. 28, 2013
(86) PCT No.: PCT/US13/52436

§ 371 Date: Jan. 27, 2015

Related U.S. Application Data
(60) Provisional application No. 61/677,408, filed on Jul. 30, 2012.

(51) Int. Cl. C08F 22/02

(52) U.S. Cl. CPC C08F 22/02

(57) ABSTRACT

A polymeric chelation system comprised of high water content at least one polymer designed with a unique combination of cross-linkers and spacer monomers chosen to enable selective uptake of specific elements from a dissolved solution. Multiple polymers can be used to extract a plurality of elements. The system is particularly beneficial in separating rare earth elements, actinides or other non-organic elements.

This application claims the benefit of U.S. Provisional Application No. 61/677,408, entitled “Polymeric Chelation System,” filed Jul. 31, 2012, the contents of which are hereby incorporated by reference.

### BACKGROUND OF INVENTION

Metal chelator compounds possess the ability to ionicaly complex metals to the electronegative atoms of their structure. This complexation is dependent upon the atom type, number of atoms, size and ionic nature of the metal, pH of the aqueous solution, and structure of the chelator as well as other factors.

The most common and well-known chelation molecule is Ethylenediaminetetraacetic acid, or EDTA. This molecule contains both nitrogen and oxygen atoms for a strong ionic bonding between the organic molecule and the metal atom. There exist limited reports of chelating polymers with only oxygen atoms as the chelating atoms where the application was to complex Ca+2 or radio-opaque therapeutic diagnostic metals. Thus, the use of just an oxygen-based chelating molecule is known, but not well explored.

The apparent reason for the less investigated, exclusively oxygen chelator molecules is that the oxygen alone does not possess a strong complexing bond to the metals. This is a desired property in our system, in that the complexation to occur to isolate and concentrate the desired rare earth elements from not only the source, which may be an ore, but also from those common elements/metals that are present in the source.

### SUMMARY OF THE INVENTION

This invention provides a system for chelating specific metals from various source material using novel acrylate based super-hydrophilic copolymers. The system provides for a means to tailor said polymers to selectively chelate metal ions based upon the chelation cavity size, chelation atoms present in the cavity and their charge density and the degree and type of cross-linking within the polymer. This is an improvement over existing methods of metal separation because of the high degree of selectivity and high chelation rates.

In the preferred embodiment, polymers rely on specific types of cross-linkers and spacer monomers to tailor for specific elements. Such cross-linkers include difunctional or trifunctional monomers of the acrylate and methacrylate classes. Spacer monomers are preferred from the cyclohexanol, decahydro-1 (or 2)-naphthol, Isoborneol, Fenchyl alcohol, 2-Methyl-1-Propanol, and other large space-filling alcohol derived monomer ester classes.

This invention further relates to the use of a plurality of polymers for the separation and isolation of mixtures of metal ions. In the preferred embodiment, each single polymer will chelate a specific metal such that an array of polymers will sequentially chelate metals from the source material.

Polymers saturated with the specific metal ion can then be subjected to a change of pH in order to release the select metal. The resultant output from the saturated polymer can then be further processed to a pure form of metallic metals or metal oxides.

### DETAILED DESCRIPTION OF THE INVENTION

Polymeric chelating compounds have been known since the mid-20th century.

They have been used for a wide variety of metal complexing to scavenge toxic heavy metals from drinking and waste water. The vast majority of applications for the removal of heavy metals have been the toxic (to mammalian species) metals like Hg (II), Cd (II), Pb (II and IV), Zn (II), Ni (II), Cr (III and VI), Cu (II), Co (II), and others. N. E. Zander reviews the use of chelating polymers for environmental remediation in an Army Research Laboratory report “Chelating Polymers and Environmental Remediation”; ARL-CR-0623; March 2009 which points out many of the short-falls of the present ion exchange resins now known and used for complexation and removal of toxic heavy metals.

The most common chelating resins contain one or more nitrogen atoms as binding sites for the metals. They may also include oxygen atoms, but will always contain at least one nitrogen per binding ligand site as exemplified in U.S. Pat. Nos. 2,765,284, 3,395,134 and 4,281,086. The most common commercial resins are: Dowex®, Amberlite®, Sephadex®, Merrifield Peptide resins®, Purex®, polyamide resins and polyethyleneimine resins, to name a few. All of these resin systems are hydrophobic, in that to maintain the resins physical rigid structure, they do not absorb more than 20-30 percent of their weight in water. This lack of water absorptivity severely limits the metal's ability to enter the resin for chelation. Thus, the resins have a very low equivalent weight exchange value.

In a departure from prior art, with this invention we propose to create polymers that have very high water absorptivity to overcome this deficiency in low uptake ability. This ability to absorb over 85 percent water (by weight) will thus open the polymer matrix up allowing large metal ions to enter the polymer structure/matrix and chelate with the polymer.

Additionally, in this invention we claim the reliance on only oxygen atoms present for the chelation. This use of only oxygen atoms is for the less strong chelation of large ions of the Rare Earth Elements (REE) of the Lanthanide metals: Lanthanum (57), Cerium (58), Praseodymium (59), Neodymium (60), Promethium (61), Samarium (62), Europium (63), Gadolinium m(64), Terbium (65), Dysprosium (66), Holium (67), Erbium (68), Thulium (69), Ytterbium (70), Lutetium (71), and the lighter REE of Scandium (21) and Yttrium (39); and other elements of the actinide series as it may be found applicable as described in this invention.

This invention provides improvements over the PUREX process, which is taught in U.S. Pat. No. 2,924,506, of purifying one or more REEs from Uranium and Plutonium from trans-uranium element mixtures containing REEs. This is accomplished with the elimination of the solvent and Tributylphophate or other complexing agents used in the extraction process.

Certain acid containing acrylic polymers are known to crosslink with metal ions to form high molecular weight polymer systems that are used to create floor polishes as demonstrated in U.S. Pat. Nos. 4,217,439 and 9,548,596 and references contained therein. While these polymers chelate a metal ion, the purpose of the chelation is to crosslink and “fix” the polymer as an insoluble film on a surface for protecting and sealing that surface. Additionally, the use of the metal for crosslinking and as a result increasing the molecular weight is such that when ammonia solution is applied to the polymer (film), the metal is released from the polymer making the polymer soluble in the wash water. This results in the removal of the film coating from the surface.

Other examples of metal chelation by a polymer is in the medicinal delivery of pharmacology active metal species to the body as described in U.S. Pat. Nos. 5,583,206 and 5,869,569 and references contained therein. Additional examples of the use of polymer chelated metals is in the design of dental cements as taught in U.S. Pat. No. 5,512,611 and references contained therein. U.S. Pat. No. 5,242,877 teaches a method to chelate metal reaction catalysts on polymers and resins for the purpose of using water as a reaction solvent and for the ease of recovery of the expensive metal catalyst.

An additional novel factor of this invention is the ability to eliminate the need for a series of Scheibel extraction columns, as described in Sella, A., Chemical Week, 2012, May, page 68, and references contained therein. Additionally, with a greater uptake efficiency, these polymers will eliminate the multi-bed polystyrene resin systems presently used to chelate the metals for isolation, there being only one or two beds necessary instead of the multiple number of columns/beds presently used.

In the preferred embodiment, the polymer will contain an acid functionalized acrylate monomer that comprises at least one of Acrylic Acid, Methacrylic Acid, Crotonic Acid, Maleic Acid and-or Itaconic Acid in combination with hydrophilic monomers of either 2-Hydroxyethyl Acrylate, 2-Hydroxyethyl Methacrylate, 2-Hydroxypropyl Acrylate, 2-Hydroxypropyl Methacrylate, 3-Hydroxypropyl Acrylate, 3-Hydroxypropyl Methacrylate, Glycerol Acrylate or Glycerol Methacrylate. Alternative embodiments may contain monomers tailored to specific applications.

In this embodiment, the polymer shall also contain difunctional monomers of the acrylate and methacrylate ester classes of cross-linking monomers, which will be selected for the purpose of providing tailored molecular weight polymers that will possess suitable rigidity and structural strength.

Examples of suitable difunctional monomers may include, but are not limited to, allyl methacrylate; allyl acrylate; PRDMA, 1, 3-propanediol dimethacrylate; BDMA, 1, 3-butanediol dimethacrylate; BDDMA, 1, 4-butanediol dimethacrylate; PDDMA, 1, 5-pentanediol dimethacrylate, NPGDMA, neopentyl glycol di-methacrylate; HDDMA, 1, 6-hexanediol dimethacrylate; NDDMA, 1, 9-nonanediol dimethacrylate; DDDMA, 1, 10-decanediol dimethacrylate; DDDDMA, 1, 12-dodecanediol dimethacrylate; PRDA, 1, 3-propanediol diacrylate; BDA, 1, 3-butanediol diacrylate; BDDA, 1, 4-butanediol diacrylate; PDDA, 1, 5-pentanediol diacrylate; NPGDA, neopentyl glycol diacrylate; HDDA, 1, 6-hexanediol diacrylate; NDDA, 1, 9-nonanediol diacrylate; DDDA, 1, 10-decanediol diacrylate; DDDDA, 1, 12-dodecanediol dimethacrylate; EGDMA, ethylene glycol dimethacrylate; DEGDMA, diethylene glycol dimethacrylate; TEDMA, triethylene glycol dimethacrylate; TEGDMA, tetraethylene glycol dimethacrylate; EGDA, ethylene glycol diacrylate; DEGDA, diethylene glycol diacrylate; TEDA, triethylene glycol diacrylate; TEGDA, tetraethylene glycol diacrylate; PEG200DMA, polyethylene glycol 200 dimethacrylate; PEG300DMA, polyethylene glycol 300 dimethacrylate; PEG400DMA, polyethylene glycol 400 dimethacrylate; PEG600DMA, polyethylene glycol 600 dimethacrylate; PEG200DA, polyethylene glycol 200 diacrylate; PEG300DA, polyethylene glycol 300 diacrylate; PEG400DA, polyethylene glycol 400 diacrylate; PEG600DA, polyethylene glycol 600 diacrylate; PPGDMA, polypropylene glycol dimethacrylate; PPGDA, polypropylene glycol diacrylate; NPG (PO) 2DMA, propoxylated (2) neopentyl glycol dimethacrylate; NPG (PO) 2DA, propoxylated (2) neopentyl glycol diacrylate; bis-MA, bisphenol A dimethacrylate; bis-GMA, bisphenol A glycerol dimethacrylate; BPA (EO) DMA, ethoxylated bisphenol A dimethacrylate (EO=1-30); BPA (PO) DMA, propoxylated bisphenol A dimethacrylate (PO=1-30); BPA (EO) DA, ethoxylated bisphenol A diacrylate (EO=1-30); BPA (PO) DA, propoxylated bisphenol A diacrylate (PO=1-30); BPA (PO) GDA, propoxylated bisphenol A glycerol diacrylate; TCDDMA, tricyclo [5.2.1.0] decanedimethanol dimethacrylates; TCDDA, tricyclo [5.2.1.0] decanedimethanol diacrylates.

An additional means of tailoring the polymer may incorporate the use of trifunctional monomers of the acrylate and methacrylate classes of cross-linking monomers.

Examples of these trifunctional monomers may include, but are not limited to, propoxylated glyceryl tri(meth)acrylate; ethoxylated trimethylolpropane trimethacrylate, ethoxylated trimethylolpropane triacrylate, propoxylated trimethylolpropane trimethacrylate, propoxylated trimethylolpropane triacrylate, ethoxylated pentaerythritol trimethacrylate, ethoxylated pentaerythritol triacrylate, ethoxylated pentaerythritol tetramethacrylate, ethoxylated pentaerythritol tetraacrylate, ethoxylated dipentaerythritol trimethacrylate, ethoxylated dipentaerythritol tetramethacrylate, ethoxylated dipentaerythritol pentamethacrylate, ethoxylated dipentaerythritol hexamethacrylate, ethoxylated dipentaerythritol triacrylate, ethoxylated dipentaerythritol tetraacrylate, ethoxylated dipentaerythritol pentaacrylate, ethoxylated dipentaerythritol hexaacrylate, propoxylated pentaerythritol trimethacrylate, propoxylated pentaerythritol triacrylate, propoxylated pentaerythritol tetramethacrylate, propoxylated pentaerythritol tetraacrylate, propoxylated dipentaerythritol trimethacrylate, propoxylated dipentaerythritol tetramethacrylate, propoxylated dipentaerythritol pentamethacrylate, propoxylated dipentaerythritol hexamethacrylate, propoxylated dipentaerythritol triacrylate, propoxylated dipentaerythritol tetraacrylate, propoxylated dipentaerythritol pentaacrylate and propoxylated dipentaerythritol hexaacrylate.

The polymer will also contain certain selected space filling monomers that allow for space between the chains such that the relatively large metal ions can pass into the polymer matrix. These monomers may include one or more of Acrylic Acid, Methacrylic Acid, Crotonic Acid, Maleic Acid and-or Itaconic Acid esters of alcohols that have large space filling characteristics. Preferentially these may be drawn from groups: cyclohexanol, decahydro-1 (or 2)—naphthol, Isoborneol, Fenchyl alcohol, 2-Methyl-l-Propanol, and other large space-filling alcohol derived monomer esters.

More preferred acrylates and methacrylates include alkyl acrylates and methacrylates such as the various isomers of methyl, ethyl, propyl, butyl, pentyl, hexyl, heptyl, octyl, n-nonyl, and n-decyl acrylates and methacrylates. Other preferred acrylates and methacrylates include hydroxyalkyl acrylates and methacrylates such as, but not limited to 2-hydroxyethyl and 3-hydroxypropyl acrylate and methacrylate. Particularly preferred hydrophilic acrylic monomers for incorporation into the polymeric compositions according to the invention include 2-hydroxyethyl acrylate, 2-hydroxyethyl methacrylate, and methacrylic acid.

An alternative embodiment of this invention is the use of Crotonate, Maleate and

Itaconate esters of 2-Hydroxyethanol, 1,2-Propanediol, 1,3-Propanediol and Glycerol.

Still other alternative spacer monomers may include, but are not limited to, methyl, ethyl, n-propyl, i-propyl, n-butyl, s-butyl, i-butyl, t-butyl, n-amyl, i-amyl, n-hexyl, 2-ethylbutyl, 2-ethylhexyl, n-heptyl, n-octyl, n-nonyl, n-decyl, cyclopentyl, cyclohexyl, benzyl, phenyl, cinnamyl, 2-phenylethyl, allyl, methallyl, propargyl, crotyl, 2-hydroxyethyl, 2-hydroxypropyl, 2-hydroxybutyl, 6-hydroxyhexyl, 5,6-dihydroxyhexyl, 2-methoxybutyl, 3-methoxybutyl, 2-ethoxyethyl, 2-butoxyethyl, 2-phenoxyethyl, glycidyl, furfuryl, tetrahydrofurfuryl, tetrahydropyryl, 2-chloroethyl, 3-chloro-2-hydroxypropyl, trifluoroethyl, and hexafluoroisopropyl acrylates, methacrylates, itaconates, maleates.

An extension of this approach and to enable tailoring the invention herein for various applications, cross-linkers of specific size may be used for specific target metals. Moreover, combinations of various cross-linkers may be used in order to enable a multi-selection system.

In the preferred embodiment, the polymerization shall be carried out in a hydrophilic low molecular weight alcohol, e.g. Methanol, Ethanol or 2-Propanol. The use of the water-soluble solvent is to facilitate the isolation, purification and hydration of the eventual polymer without resorting to labor intensive processes like vacuum drying and grinding, which may also present potential dust hazards.

The polymerization for this embodiment will be catalyzed-initiated by any of the common organic initiators soluble in the solvent system from the classes of initiators comprising azo and peroxy compound commonly known to those skilled in the arts of polymerization. Organic REDOX catalysis may be used if that REDOX initiation system does not require a metal co-catalyst (such as Iron or Cerium).

Polymers designed in accordance with this invention will preferentially complex the rare earth metals in the polymer, while the more common metals chelate less strongly, and then when extracting the metals from the polymer, because they are less strongly chelated, the desired metals can be removed from the polymer by a pH change only rather than the traditional use of cyanide ion or other environmentally harsh and expensive chemicals.

Still another variation for metal removal is the ability to dissolve or dispose of the polymeric compound thereby enabling the metal to be easily separated. Such dissolution or disposition may be performed via chemical, mechanical, electrical, thermal, optical or biological means.

An enhancement to invention is the incorporation of compounds into the material that will provide a distinct indication of chelation that is beyond complex analysis. Such enhancement may include color change, whether in the visible or extra-visual spectrum (e.g., UV) or the detection of changes in electrical resistivity or capacitance indicating changes in chelation.

### EXAMPLE

Using a synthesis process that would be familiar to those knowledgeable about such processes, and monomers as described above, this example demonstrates the use of the hydrated polymer cited or variation there of as an agent for the chelation, isolation and purification of metals, particularly those known as the Rare Earth Elements (REE). The example relies specifically on the absorbent methacrylate polymer disclosed in U.S. Pat. No. 6,201,089, Carter, and U.S. Pat. No. 6,326,446, Carter, which was fully hydrated in distilled water in accordance with those patent specifications.

It is important to note that while the cited polymers were used for this example, they are distinct from the invention herein, which embodies and describes polymers with a specific chelation cavity size designed to chelate a metal of defined and specific ionic radii, thus allowing for the separation of that metal ion from a mixture of metal ions in solution.

In this example, a tank containing a mixed REE ore solution (after acid digestion and filtering according to the various manufacturing processes common in industry) that is neutralized to a pH of 5.5 to 7.0 with a caustic solution. Agitation is started and to this tank is added an excess of the hydrated polymer. Agitation at ambient temperature is maintained until all of the REE is chelated from the solution.

The progress is monitored by metal analysis employing an atomic absorption or emission spectrometer to measure the metal content in the water. Upon complete chelation of the metals, the agitation is stopped and the water removed. The polymer is then mixed with dilute hydrochloric acid to effect to removal of the metals from the polymer. The metal compounds are then further processed as known in the industry.

By experimentation, a solution of approximately 2000 ppm of a rare earth element salt was mixed with two (2) grams of the hydrated polymer for 24 hours. The table below shows the percent chelation of the salts with the polymer.

| Salt | Percent Chelation |
|---|---|
| Cerium Ammonium | 8.1% |
| Sulfate | |
| Ytterbium Sulfate | 100% |
| Europium Chloride | 0% |

An additional four (4) grams of the hydrated polymer was added to the Cerium salt. This resulted in a percent chelation of 22.5 percent. This shows that the polymer is capable of chelation of Rare Earth Element salts, and that there is differentiation of the elements in chelation. This differentiation in chelation can be utilized to isolate one element from another without the use of previously known technologies.

This example could well have been implemented with an alternate format of the chelation process in which the polymer and water are loaded into a resin column to form a bed rather than performing the chelation in a tank. The neutralized/filtered ore mixture is pumped through the bed to effect chelation of the metals to the polymer. Upon saturation of the polymer bed, the bed is washed with water to clean out unchelated, undesirable metals. To release the metals from the polymer bed, a dilute solution of hydrochloric acid is pumped through the bed. The metal compounds in solution are further refined as is known in the industry.

A variation on the preferred use of dilute hydrochloric acid for the removal of the metal from the chelating polymer may include the use of electrochemical or electromagnetic systems found in today's industrial processes.

An enhancement to this invention is to allow the recycling and reuse of polymer that has been previously used for chelation. Upon separation of the desired metal from the polymer, the polymer may be used again. This may be done in either a batch or continuous process. The continuous process may be implemented in a way that allows for addition of polymer to replace any that may not be recovered. Further, it may include a step to process the polymer to return it to a preferred state.

In an alternative embodiment, hydration of the polymer may be performed with solutions other than water. Selection of such alternative hydration solutions may optimize performance for specific elements to be chelated or to be preferentially avoided.

Another alternate embodiment introduces additional compounds or secondary polymer formulations may be incorporated in order to enhance uptake or selectivity. An example application for increasing uptake is the ability to chelate multiple heavy elements out of water or soil during a remediation process.

Yet another enhancement of this invention is the combination of differently hydrated polymers to selectively chelate multiple metals. This may be further used in conjunction with other polymeric chelation systems in order to maximize yield of multiple elements chelated in a single processing operation.

While specific processes and compounds are cited in this description, it will be well understood by those schooled in the art that variations are possible. Nothing in this description is to be read as limiting with respect to such potential variations. Moreover, while rare earth elements are used for example purposes, the invention disclosed herein may be applicable to other categories of elements. Further, terms like resin, chelating compounds and chelating polymers are used interchangeably and do not necessarily draw specific inferences to their use.

1. A polymeric chelation system comprising:
at least one polymer comprising oxygen bonding chelation, wherein said polymer being has a high water content-design, and
said polymer comprises cross-linkers and spacer space filling monomers for selective chelation of a specific ionic metal element out of a dissolved mix of elements, and able to release said specific ionic metal element.

2. The polymeric chelation system of claim 1 wherein said polymer comprises only oxygen bonding chelation.

3. The polymeric chelation system of claim 1 wherein said space filling monomers are selected from the group consisting of Acrylate, Methacrylate, Itaconate, Maleate and Crotonate monomers with a reactive carbon-carbon double bond.

4. The polymeric chelation system of claim 1 wherein said polymer comprises between 20 to 80 percent by weight an acid monomer selected from the group consisting of Acrylic Acid, Methacrylic Acid, Itaconic Acid, Maleic Acid and/or Crotonic Acid.

5. The polymeric chelation system of claim 1 wherein said polymer comprises between 60 to 70 percent by weight of an acid monomer selected from the group consisting of Acrylic Acid, Methacrylic Acid, Itaconic Acid, Maleic Acid and/or Crotonic Acid.

6. The polymeric chelation system of claim 1 wherein said polymer comprises 50 percent by weight of an acid monomer selected from the group consisting of Acrylic Acid, Methacrylic Acid, Itaconic Acid, Maleic Acid and Crotonic Acid.

7. The polymeric chelation system of claim 1 wherein said polymer comprises a hydrophilic monomer derived from 2-Hydroxyethyl ester of Acrylic Acid, Methacrylic Acid, Itaconic Acid, Maleic Acid or Crotonic Acid.

8. The polymeric chelation system of claim 1 wherein said polymer comprises a hydrophilic monomer derived from 2-Hydroxypropyl ester of Acrylic Acid, Methacrylic Acid, Itaconic Acid, Maleic Acid or Crotonic Acid.

9. The polymeric chelation system of claim 1 where said polymer comprises between 20 to 80 percent by weight hydrophilic monomer.

10. The polymeric chelation system of claim 9 where said polymer comprises between 40 to 60 percent by weight hydrophilic monomer.

11. The polymeric chelation system of claim 10 where said polymer comprises 50 percent by weight hydrophilic monomer.

12. The polymeric chelation system of claim 1 wherein said cross-linkers comprise difunctional monomers.

13. The polymeric chelation system of claim 1 wherein said cross-linkers comprise trifunctional monomers.

14. The polymeric chelation system of claim 1 where said polymer comprises 0 to 25 percent by weight said crosslinking monomer.

15. The polymeric chelation system of claim 14 wherein said crosslinking monomer is between 0 and 10 percent by weight of the polymer.

16. The polymeric chelation system of claim 1 wherein said space filling monomers are Acrylate, Methacrylate, Itaconate, Maleate and Crotonate class monomers.

17. The polymeric chelation system of claim 1 where the space filling monomers are 0 to 25 percent by weight of the polymer.

18. The polymeric chelation system of claim 1 where the space filling monomers is are between 0 and 10 percent by weight of the polymer.

19. The polymeric chelation system of claim 1 wherein said specific ionic metal element is a lanthanide.

20. The polymeric chelation system of claim 1 wherein said specific ionic metal element is an actinide.

21. The polymeric chelation system of claim 1 wherein said specific ionic metal element is a precious metal.

22. The polymeric chelation system of claim 1 wherein said release that is enabled by a change of pH.

23. The polymeric chelation system of claim 1 wherein said release is by other than a change of pH.

24. A polymer chelation system comprising multiple polymers, said polymers being of high water content design, wherein each polymer of said polymers comprises cross-linkers and space filling monomers selected to enable selective chelation of specific ionic metal elements out of a dissolved mix of element, and able to release said specific ionic metal elements.

25. The polymer chelation system of claim 24 wherein said multiple polymers are arranged separately and in series such that a serial flow of dissolved elements will pass in sequence, extracting a specific element at each step of the sequence.

26. The polymer chelation The system of claim 24 wherein said multiple polymers are combined to enable multiple elements to be extracted at one time.

27. The polymer chelation system of claim 24 comprising oxygen bonding chelation coordination sites.

28. The polymer chelation system of claim 24 wherein said polymers comprise monomers selected from the group consisting of Acrylate, Methacrylate, Itaconate, Maleate and Crotonate containing a reactive carbon-carbon double bond.

29. The polymer chelation system of claim 24 wherein said polymers comprise between 20 to 80 percent by weight elan acid monomer selected from the group consisting of Acrylic Acid, Methacrylic Acid, Itaconic Acid, Maleic Acid and/or Crotonic Acid.

30. The polymer chelation system of claim 24 wherein said polymers comprise between 60 to 70 percent by weight an acid monomer selected from the group consisting of Acrylic Acid, Methacrylic Acid, Itaconic Acid, Maleic Acid and Crotonic Acid.

30. The polymer chelation system of claim 24 wherein said polymers comprise 50 percent by weight elan acid monomer selected from the group consisting of Acrylic Acid, Methacrylic Acid, Itaconic Acid, Maleic Acid and/or Crotonic Acid.

32. The polymer chelation system of claim 24 wherein said polymers comprise a hydrophilic monomer derived from 2-Hydroxyethyl ester of Acrylic Acid, Methacrylic Acid, Itaconic Acid, Maleic Acid and/or Crotonic Acid.

33. The polymer chelation system of claim 24 wherein said polymers comprise a hydrophilic monomer derived from 2-Hydroxypropyl ester of Acrylic Acid, Methacrylic Acid, Itaconic Acid, Maleic Acid or Crotonic Acid.

34. The polymer chelation system of claim 24 wherein said polymers comprise between 20 to 80 percent by weight hydrophilic monomer.

35. The polymer chelation system of claim 24 wherein said polymers comprise between 40 to 60 percent by weight hydrophilic monomer.

36. The polymer chelation system of claim 24 wherein said polymers comprise 50 percent by weight hydrophilic monomer.

37. The polymer chelation system of claim 24 wherein said cross-linkers are difunctional monomers.

38. The polymer chelation system of claim 24 wherein said cross-linkers are trifunctional class of monomers.

39. The polymer chelation system of claim 24 wherein said polymers comprise 0 to 25 percent by weight crosslinkers.

40. The polymer chelation system of claim 24 wherein said polymers comprise between 0 and 10 percent by weight crosslinkers.

41. The polymer chelation system of claim 24 wherein said space filling monomers comprise acrylate and methacrylate monomers.

42. The polymer chelation system of claim 24 where the polymer comprises 0 to 25 percent by weight said space filling monomers.

43. The polymer chelation system of claim 24 where the polymer comprises between 0 and 10 percent by weight said space filling monomers.

44. The polymer chelation system of claim 24 wherein said specific ionic metal elements are lanthanides.

45. The polymer chelation system of claim 24 wherein said specific ionic metal elements are actinides.

46. The polymer chelation system of claim 24 wherein said specific ionic metal elements are a precious metal.

47. The polymer chelation system of claim 24 wherein said release is enabled by a change of pH.

48. The polymer chelation system of claim 24 wherein said release is by other than change of pH.

49. The polymeric chelation system of claim 1 wherein said polymer has a water absorptivity of over 85 weight percent.
